(19) United States
(12) Patent Application Publication
(10) Pub. No.: US 2008/0033742 A1
(43) Pub. Date: Feb. 7, 2008

(54) METHOD AND APPARATUS FOR PERFORMING EMPLOYEE BACKGROUND CHECKS

(75) Inventor: Charles E. Bernasconi, Mukilteo, WA (US)

Correspondence Address: YOUNG & BASILE, P.C., 3001 WEST BIG BEAVER ROAD, SUITE 624, TROY, MI, 48084, US

(73) Assignee: NATIONAL SURVEYS ONLINE, LLC., Clinton, WA (US)

(21) Appl. No.: 11/833,528

(22) Filed: Aug. 3, 2007

Related U.S. Application Data
(60) Provisional application No. 60/835,205, filed on Aug. 3, 2006.

(51) Int. Cl. G06Q 99/00; G06F 15/16

(52) U.S. Cl. 705/1; 709/206

(57) ABSTRACT

A method and apparatus for performing background checks on potential new employees. After an employer enters identifying information for the potential new employee, the employee completes information related to prior employers, if any, through the use of a unique access code as part of an electronic signature. An automated request is sent to the prior employer(s) to complete a background check, and the new employer retrieves the response Reminders are sent to the prior employer(s) in the event they do not respond during a prescribed time period.

### CROSS REFERENCE TO RELATED APPLICATION

This application claims priority to U.S. Provisional Patent Application Ser. No. 60/835,205, filed Aug. 3, 2006.

### FIELD OF INVENTION

The disclosure relates generally to a method and apparatus for performing employee employment records checks for misconduct.

### BACKGROUND

Background checks are used to ensure that new employees do not have disqualifying events in their prior employment. Traditionally, background checks are time consuming and require a lot of paper work.

### BRIEF SUMMARY

Methods are taught herein to perform employee background checks. One method for performing a prior employment record check on an employee comprises providing a database for a new employer to enter at least a name and a contact address for a new employee, requiring a submission of a unique access code with a designation of either no prior employers or at least one prior employer by the new employee, making a first request to each prior employer to conduct a records check of the new employee when there exists at least one prior employer and forwarding a response from each prior employer to the new employer when there exists at least one prior employer.

Embodiments of an apparatus for performing employee background checks are also taught herein. One such apparatus comprises, by example, a database configured for a new employer to enter at least a name and a contact address for a new employee, means for requiring submission of a unique access code with a designation of either no prior employers or at least one prior employer by the new employee, means for making a first request to each prior employer to conduct a records check of the new employee when there exists at least one prior employer and means for forwarding a response to the first request from each prior employer to the new employer when there exists at least one prior employer.

These embodiments, and inventive features of these and other embodiments, are discussed in additional detail hereinafter.

### BRIEF DESCRIPTION OF THE DRAWINGS

Various features, advantages and other uses of the invention will become more apparent by referring to the following detailed description and drawings in which:

FIG. 1 is a block diagram of the steps in one example of performing employee background checks as taught herein;

FIG. 2 is a block diagram of an embodiment in which prior employers are requested to perform a records check every N days until they comply;

FIG. 3 is a block diagram of the steps taken by the prior employer in an embodiment;

FIG. 4 is a diagram showing an embodiment in which the databases are located on a server and accessed by each party's computer.

### DETAILED DESCRIPTION

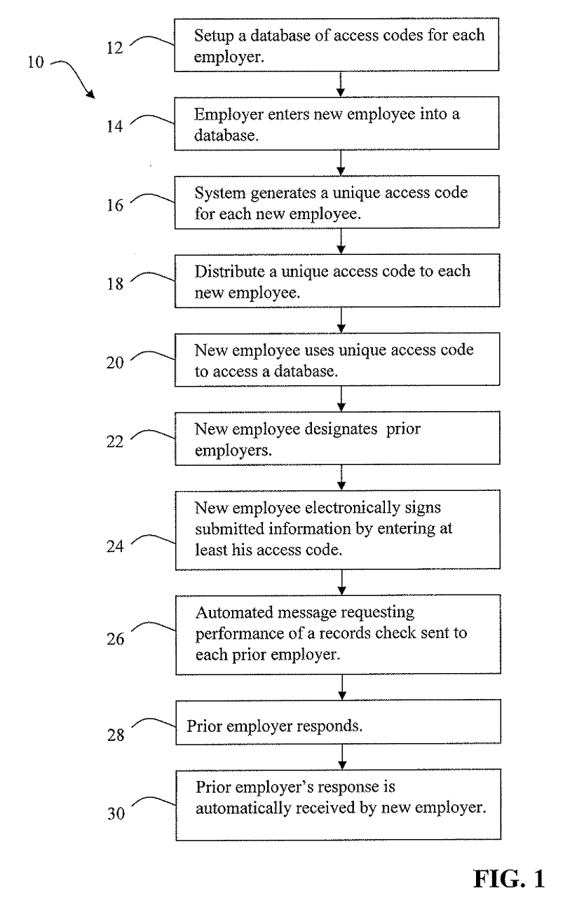

Referring now to FIG. 1, one embodiment 10 of performing a background check according to the invention is shown. In step 12, a database for access codes for employers is set up. This database is, for example, setup on a central server and is accessible on-line through an Internet connection or otherwise. An employer receives a unique access code for data entry and other access codes after subscribing to the service as discussed herein. A dedicated database could be assigned to each employer, or a single database with only certain data accessible to each employer based on the employer's unique access code is also possible.

After the database is set up, an employer uses its unique access code to enter data related to a new employee into the database in step 14. If the database is on-line, by way of the previous example, the employer can access it via a website to enter the new employee data. Such data includes at least name and contact information, such as email address and/or telephone number. After the employer enters the data, a unique employee access code for the new employee is generated in step 16. Instead of or in addition to displaying the employee access code for the new employee, the employee access code can be otherwise sent to the employer via email or regular mail.

Step 18 occurs when the unique employee access code is distributed to the new employee. The employer can call in the access code to the new employee or print a hard copy of the access code and mail or hand it to the new employee. Alternatively, the employer can email the code.

After receiving his or her employee access code, a new employee uses the access code to access the database in step 20. The database is accessible to the new employee using the unique employee access code, preferably on-line through a website portal. In step 22, the employee verifies either that no prior employers exist or designates former employers. This step may be accomplished, for example, by presenting a list of employers in the same field as the new employer for the new employee to select from and supplementing the list with a blank employer information form. For example, if the new employee is a school janitor then the pull-down list could include nearby school districts.

Then, in step 24, the new employee electronically signs an agreement using at least his unique access code. The electronic signature can optionally be used to stipulate that the new employee will not sue employers who respond to the background check. The electronic signature can also include additional identifying information, such as the new employee's legal name, the last four digits of his social security number and/or his date of birth in order to increase validity of the electronic signature.

At this point, step 26 features an automated message requesting performance of a records check of the new employee that is transmitted to the designated prior employers. This response can be sent via email, for example, from a template stored on the same server as the database. It would be helpful for the request to include instructions on how to respond. Additionally, response choices for prior employers can optionally be limited to, for example, “Yes” or “No”. Prior employers could also be permitted to make any additional comments. This would allow individuals that had worked with the new employee, such as co-workers or subordinates, to provide input. The message that the prior employer receives can also have a hyperlink to the database and the employee's signed form. The prior employer can log on with their own unique access code and view the database form the employee has signed. After completing the form and signing it electronically, the prior employer or its agent submits the form. This form updates the database and the records for the new employer.

After a prior employer submits her response in step 28, that response is forwarded to the new employer in step 30. Email is a possible way of performing both steps 28 and 30 since it is capable of transmitting messages nearly instantaneously. Alternatively, the secured database can be updated. That is, if the prior employer also has a unique employer access code, the prior employer can receive the message and update the database. Then, the new employer can receive a message after the update to check the database using its unique employer access code.

The response is preferably, although not necessarily, reformatted from the format of the database into a format that is more quickly read by the new employer. For example, a chart showing each prior employer could be filled in with green highlighting if the new employee cleared the background check and red highlighting if he did not. In this example, the new employer would have a quick reference tool to observe the state of the background check, including any failure to respond by a prior employer.

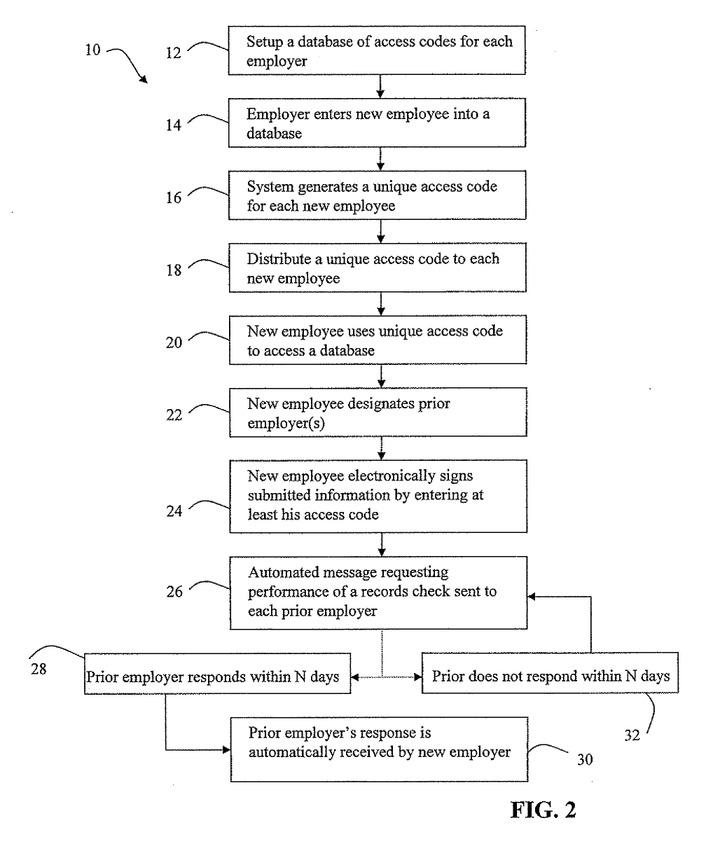

Referring to FIG. 2 now, additional step 32 is added. In this step, if the former employer does not respond within a certain number of days, N, then the former employer receives another request for a response including directions to respond. Once the former employer has responded, it will no longer receive requests for a response via email or otherwise. The addition of this step may aid in ensuring the overall effectiveness of the method 10 by increasing the response rate from former employers. This step is preferably automated by software.

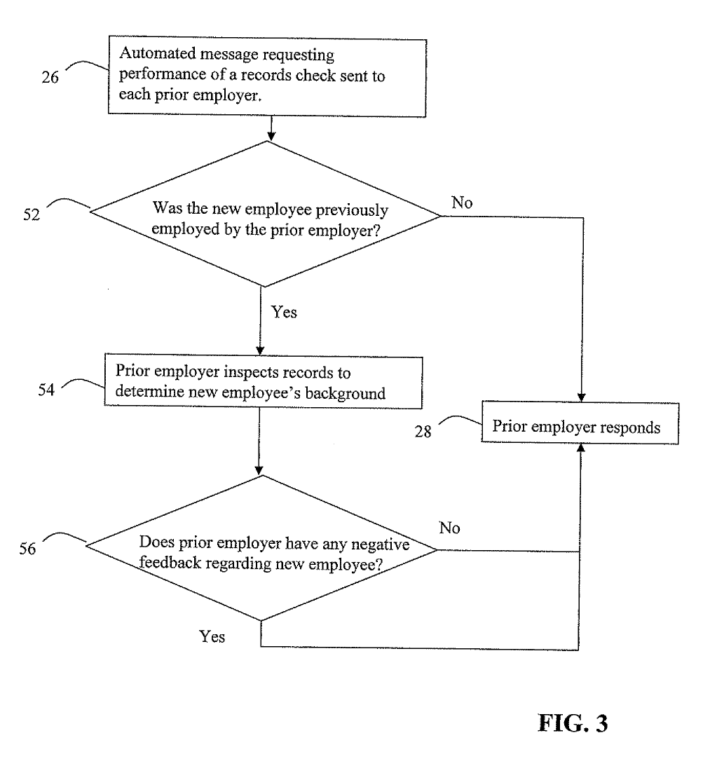

Referring to FIG. 3, shown are the steps taken by the prior employer after the automated message requesting performance of a records check 26 is sent to the prior employer and before the prior employer responds 28. First, the prior employer must determine whether it has actually employed the new employee 52. If the prior employer has never employed the new employee, the prior employee will not have any information on the new employee. In this event, the prior employer can respond at step 28 by merely informing the new employer that it does not have any information on the new employee. Assuming the prior employer did employ the new employee at some point in the past, the prior employer inspects its records at step 54 to determine whether it has any negative feedback regarding the new employee. The prior employer then responds at step 28 to the new employer in both the situations in which the prior employer does and does not have any negative feedback at step 56 regarding the new employee.

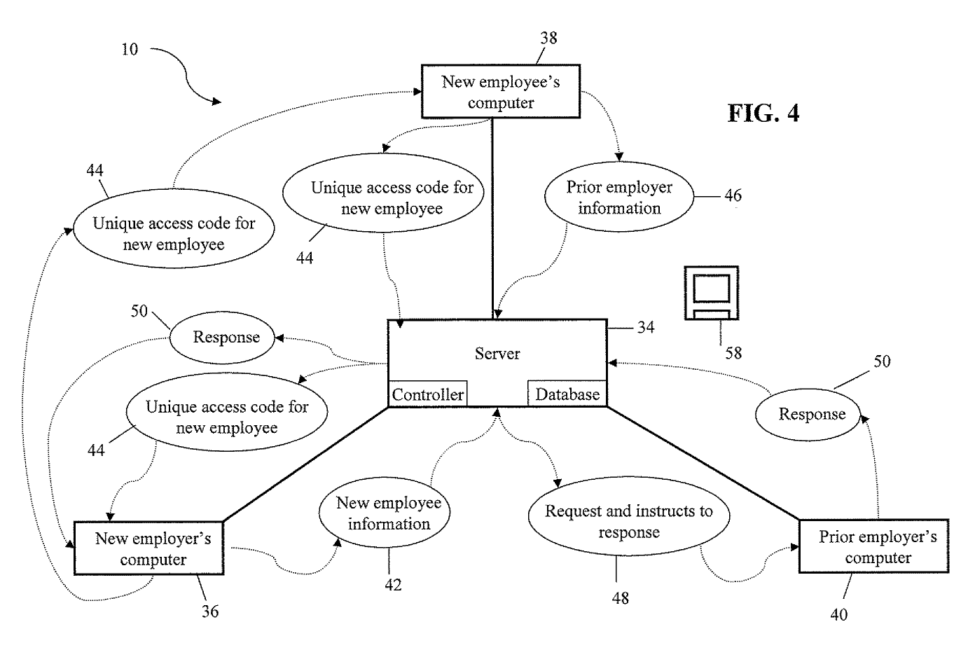

FIG. 4 shows an embodiment in which the database for all interactions is contained on a server 34. The new employer connects to the server 34 using his computer 36. This connection may be made through a website address. The process described is implemented by a controller of the server 34. The controller has a well-known configuration in that it can be, for example, a microcomputer including a central processing unit (CPU), input and output ports (I/O), random access memory (RAM), keep alive memory (KAM), a common data bus and read-only memory (ROM) as an electronic storage medium for one or more executable software programs operating the process as previously described. The database can be stored in RAM or external memory of the server 34. Alternatively, the process described can be implemented by software loaded onto a computer-readable storage medium such as disk 58 that is operated by the controller of the server 34. In this case, the database could be stored on the disk 58.

The new employer uses his computer 36 to relay the new employee's information 42 to the server 34. The server 34 then returns a unique access code 44 for the new employee using a random password generator such as those known in the art. The new employer can physically transfer the access code 44 to the new employee, or he could email it to the new employee's computer 38. Optionally, but less preferably, the server 34 can send the access code 44 to the new employee. In any event, the new employee uses his computer 38 and the access code 44 to login to the server 34.

Once the new employee has logged in, he may enter information 46 about his prior employer. If a website was used by the new employer, the same site could be used by the new employee to enter prior employer information 46. The server 34 generates and sends emails to each of the prior employers' computers 40 requesting that they perform records checks and providing instructions 48 on performing the checks. The prior employer responds 50 to the request 48, and his response 50 is routed through the server 34, where it may be reformatted before being relayed to the new employer's computer 36. The reformation step is not necessary, but may be helpful to provide a more easily viewed summary of the background check results. For example, a chart with green and red highlights could be used as explained above. The results 50 sent to the new employer could be sent via email, or they could be posted on a website accessible with a code known only by the new employer.

One embodiment screens new employees at schools. Some states have laws requiring all school districts to contact prior employers of new employees to check if the new employee has a record of sexual misconduct. One such state, Washington, requires only a “Yes”, “No”, or “Never employed” answer where a “Yes” response indicates that there is a problem with the new employee's record with respect to sexual misconduct. Washington allows prior school district employers twenty-days to respond to a background check. According to the teachings herein, immediately after the prior employer responds, the hiring district would be notified via the database or email, thereby easing compliance with the twenty-day limit. A table could be set up such that a “No” response would trigger a green highlight appearing on a table of employers. This would allow for a quick graphical reference of the state of the background check. If a “Yes” answer is received by the hiring district, it could then take proper procedures to verify and deal with the situation.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for performing a prior employment record check on an employee, the method comprising:
providing a database for a new employer to enter at least a name and a contact address for a new employee;
requiring submission of a unique access code with a designation of either no prior employers or at least one prior employer by the new employee;
making a first request to each prior employer to conduct a records check of the new employee when there exists at least one prior employer; and
forwarding a response from each prior employer to the new employer when there exists at least one prior employer.

2. The method according to claim 1, further comprising:
distributing a unique access code to the new employee.

3. The method according to claim 2, further comprising:
requesting the new employee make the designation of either no prior employers or the at least one prior employer.

4. The method according to claim 1, further comprising:
requesting a first prior employer conduct the records check of the new employee when the first prior employer fails to respond to the first request with a predetermined number of days.

5. The method according to claim 1, further comprising:
sending reminders to conduct the records check of the new employee to those of the prior employers not responding to the first request within a predetermined number of days.

6. The method according to claim 1, further comprising:
preparing a reminder list including each prior employer; and
removing a prior employer from the reminder list after the prior employer sends the response to the first request.

7. The method according to claim 6, further comprising:
sending reminders to conduct the records check of the new employee to those of the prior employers on the reminder list when a predetermined number of days passes after making the first request.

8. The method according to claim 1 wherein forwarding the response from each prior employer to the new employer further comprises:
transmitting a notification of the response to the new employer; and
posting the response to the database.

9. The method according to claim 8, further comprising:
requiring submission of a unique employer identification code to enable the new employer to access the response from the database.

10. The method according to claim 1, further comprising:
requesting the new employee make the designation of either no prior employers or the at least one prior employer.

11. The method according to claim 1, wherein forwarding a response from each prior employer to the new employer further comprises:
reporting that a first prior employer failed to send the response when the first prior employer does not respond to the first request and any reminders when a predetermined period of time has passed.

12. An apparatus for performing a prior employment record check on an employee, the apparatus comprising:
a database configured for a new employer to enter at least a name and a contact address for a new employee;
means for requiring submission of a unique access code with a designation of either no prior employers or at least one prior employer by the new employee;
means for making a first request to each prior employer to conduct a records check of the new employee when there exists at least one prior employer; and
means for forwarding a response to the first request from each prior employer to the new employer when there exists at least one prior employer.

13. The apparatus according to claim 12, further comprising:
means for requesting the new employee designate either no prior employers or the at least one prior employer.

14. The apparatus according to claim 12, further comprising:
means for tracking responses from each prior employer;
means for requesting a first prior employer conduct the records check of the new employee when the tracking means indicates that the first prior employer fails to respond to the first request within a predetermined number of days.

15. The apparatus according to claim 12, further comprising:
a reminder list including each prior employer; and
means for removing a prior employer from the reminder list after the prior employer sends the response to the first request.

16. The apparatus according to claim 15, further comprising:
means for sending reminders to conduct the records check of the new employee to those of the prior employers on the reminder list when a predetermined number of days passes after making the first request.

17. A computer-readable storage medium storing thereon a method executable by a computer for performing a prior employment record check on an employee, the method comprising:
providing a database for a new employer to enter at least a name and a contact address for a new employee;
requiring submission of a unique access code with a designation of either no prior employers or at least one prior employer by the new employee;
making a first request to each prior employer to conduct a records check of the new employee when there exists at least one prior employer; and
forwarding a response from each prior employer to the new employer when there exists at least one prior employer.

18. The computer-readable storage medium according to claim 17 wherein forwarding a response from each prior employer to the new employer further comprising:
transmitting a notification of the response to the new employer; and
posting the response to the database.

19. The computer-readable storage medium according to claim 18 wherein the method further comprises:
requiring submission of a unique employer identification code to enable the new employer to access the response from the database.

20. The computer-readable storage medium according to claim 17 wherein the method further comprises:
sending reminders to conduct the records check of the new employee to those of the prior employers not responding to the first request within a predetermined number of days.
